(19) United States
(12) Patent Application Publication
(10) Pub. No.: US 2015/0032472 A1
(43) Pub. Date: Jan. 29, 2015

(54) TOTAL QUALITY MANAGEMENT FOR HEALTHCARE

(71) Applicant: Kimberly A. Dunn, Bellaire, TX (US)

(72) Inventors: Kimberly Ann Dunn, Houston, TX (US); Kenneth Andrew Dunn, Houston, TX (US)

(73) Assignee: KDunn & Associates, P.A., Bellaire, TX (US)

(21) Appl. No.: 14/148,133

(22) Filed: Jan. 6, 2014

Related U.S. Application Data
(60) Provisional application No. 61/749,341, filed on Jan. 6, 2013.

(51) Int. Cl. G06Q 10/06; G06Q 50/24

(52) U.S. Cl. CPC G06Q 10/06395; G06Q 50/24
USPC 705/3

(57) ABSTRACT

A model and method for total quality management in healthcare data management includes receiving healthcare related goals determined by a patient. A healthcare record associated with the patient is maintained and stored in a database. The healthcare record pertains to the healthcare related goal(s) from at least one healthcare service provider. Performance of activities of the healthcare service provider(s) is evaluated with respect to achieving the healthcare related goal(s). Feedback is provided to the patient regarding the performance evaluation of the healthcare service provider(s).

### CROSS-REFERENCE TO RELATED APPLICATIONS

The present application claims priority to U.S. Provisional Patent Application No. 61/749,341, filed Jan. 6, 2013 entitled TOTAL QUALITY MANAGEMENT FOR HEALTHCARE, which is incorporated herein by reference in its entirety.

### TECHNICAL FIELD

The present disclosure relates to healthcare management services and more particularly to total quality management for healthcare services.

### BACKGROUND

Currently, the organization of healthcare services is generally based on particular healthcare delivery systems, rather than the patient. For example, doctors are paid based on services that they document during an encounter with a patient, rather than outcomes of their care.

Healthcare information, which is vital to providing healthcare services, has heretofore been very poorly managed. For example, doctors and other health care providers generally are not assured of having access to all of a patient's information at the time of an encounter with the patient. Patients who wish to provide their healthcare information to be provided to all of their providers generally must themselves take affirmative steps to ensure that the information is available to the providers.

Doctors who are expected to provide patients with a copy of their encounter notes often do not do so. Therefore, it has been difficult for patients to assure that their healthcare information or their care is coordinated among various providers. Moreover, providers and patients are often burdened by entering the same data on multiple forms and entering redundant data into multiple systems.

### SUMMARY

Aspects of the present disclosure include a model of care for value based care management that embeds total quality management into care. According to aspects of the present disclosure, the model includes an efficient method for providers to document their care by interacting with the consumer's “Quality Health Record.” The model also incorporates telemedicine services to improve access while saving money. According to aspects of the present disclosure, the model also includes a method to collect core outcomes data on all patient encounters as part of the care delivery process by using core communication standards. Aspects of the present disclosure also include methods to drive adoption by both providers and consumers.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIGS. 1-13 are process flow diagrams showing workflow practice and standards of practice for information management for defined types of healthcare service encounter according to aspects of the present disclosure.

FIGS. 14A-14C show a data structure diagram illustrating an example of a Quality Health Record according to aspects of the present disclosure.

FIG. 15 is conceptual diagram illustrating, a provider care card according to aspects of the present disclosure.

FIG. 16 is process flow diagram showing an example of method of total quality management of healthcare activities according to aspects of the present disclosure.

FIG. 17 is conceptual diagram illustrating, a total quality management system for managing healthcare activities according to aspects of the present disclosure.

### DETAILED DESCRIPTION

Embodiments of the present disclosure will be described herein with reference to the accompanying drawings. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout. As used herein the term “and/or” includes any and all combinations of one or more of the associated listed items and may be abbreviated as “/”.

The integration of quality of care and cost of care to provide value based care contracting for healthcare services is an emerging concept in the healthcare industry. It is generally believed that the provision of healthcare services should be based on payment for outcomes of care, rather than payment based merely on service of care. Value can generally be defined as a quality measure divided by a cost. Historically it has been difficult or practically impossible to implement value based health care services due to a number of key challenges.

A first key challenge results from the lack of verifiable standards of practice in health care. Another key challenge result from the lack of quality measurements for patient encounters. Quality not routinely measured on all patient encounters. A key step to assure quality is to assure that patients understand and follow certain expected patient tasks. This allows the patients to be accountable for their own contribution to quality outcomes of care. Given that quality data is not routinely collected and data on patient adherence is not routinely measured, it has been a challenge to implements effective doctor quality improvement programs.

At least from the patients' perspective, one component of value in healthcare services is the ability to access doctors and other health care providers remotely, via telephone, email, and/or other means of telemedicine, for example. Another component of value in healthcare services is the level to which providers apply the most up to date knowledge and practices for their particular practice area. Current healthcare systems generally lack assurances that doctors and other providers are up-to-date on their treatment practices.

At least from the healthcare providers' perspective, a key component of value in healthcare is an assurance of timely and adequate payment for services. Currently cost data for healthcare services is not generally accessible in real time. Thus financial management has been very difficult for doctors and other healthcare providers who do not know when they will be paid or what amount of compensation they should expect for their services.

Aspects of the present disclosure provide a framework for implementing value based care services based on total quality management techniques. A total quality management model according to aspects of the present disclosure starts with the establishment of standards of practice for information management, communication standards, and outcomes collection for ambulatory and institution based care. According to an aspect of the present disclosure, the model is patient-centered, allows the patient to access telemedicine and continuously reconciles the patient's care plan to include providers' treatment recommendations. The model includes algorithms to collect outcomes and patient adherence on healthcare encounters.

According to aspects of the present disclosure, adoption of the model is driven by payment of providers at the point of service completion if standards are met. The model also provides feedback and a practice based improvement program to assist providers to continuously improve quality and decrease total cost of care. The practice based improvement program may include adjustment of population health for patient social/clinical risk factors and adherence, service and education improvement, and updates to the provider knowledge base to assure that practitioner is up-to-date, for example.

According to aspects of the present disclosure, the system of care includes a data model and information system referred to herein as a “Quality Health Record.” The Quality Health Record provides core patient data to “smart forms” or electronic record systems. This reduces or eliminates inefficiencies that result from duplicate data entry and implements continuous collection of actionable quality data as part of the care delivery process.

According to aspects of the present disclosure, data from the Quality Health Record is used to provide peer comparison reports and a process for providers to improve quality (population health, service, and knowledge) and decrease cost.

### Standards of Practice

Aspects of the present disclosure define standards of practice for care delivery, communication, and information management to collect outcomes of care on patient encounters in a patient centered care system. According to aspects of the present disclosure a number of encounter types that a consumer can have with their healthcare delivery system are identified. The encounter types include both ambulatory encounters and institutional encounters, for example. For each of the identified encounter types, aspects of the present disclosure include a best workflow practice and standards of practice for information management. The best workflow practice and standards of practice for information management assure that the care plan is reconciled, care responsibilities are defined for all members of the consumer's care team, tasks are assigned (including the patient's) and outcomes are defined and collected.

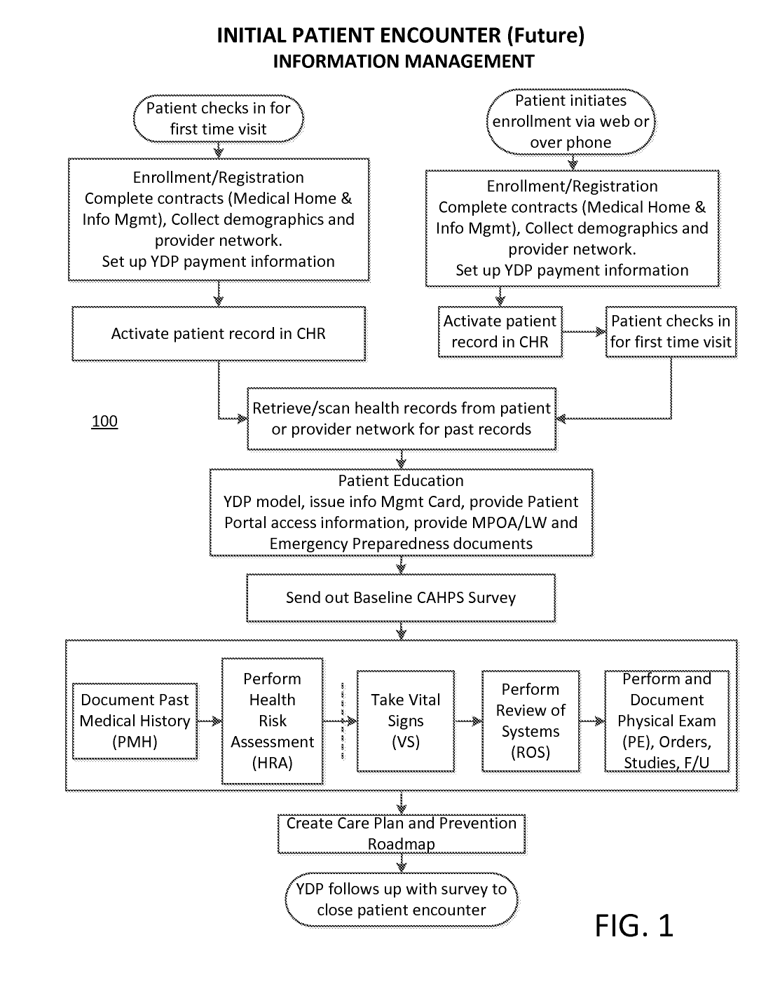

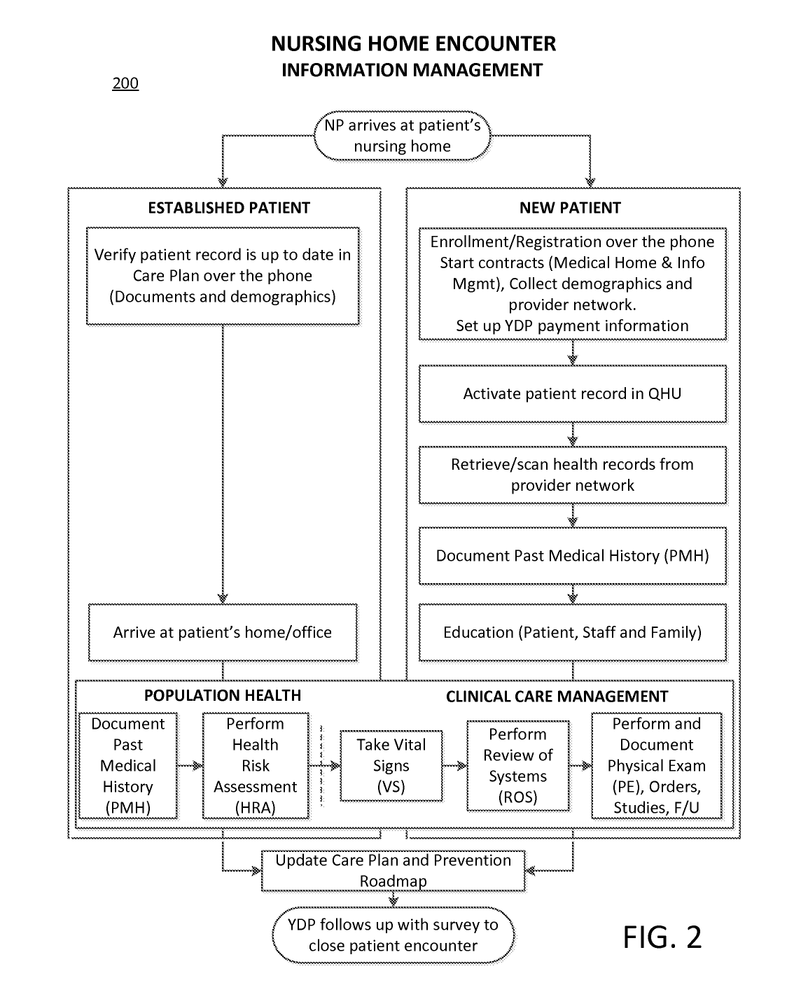

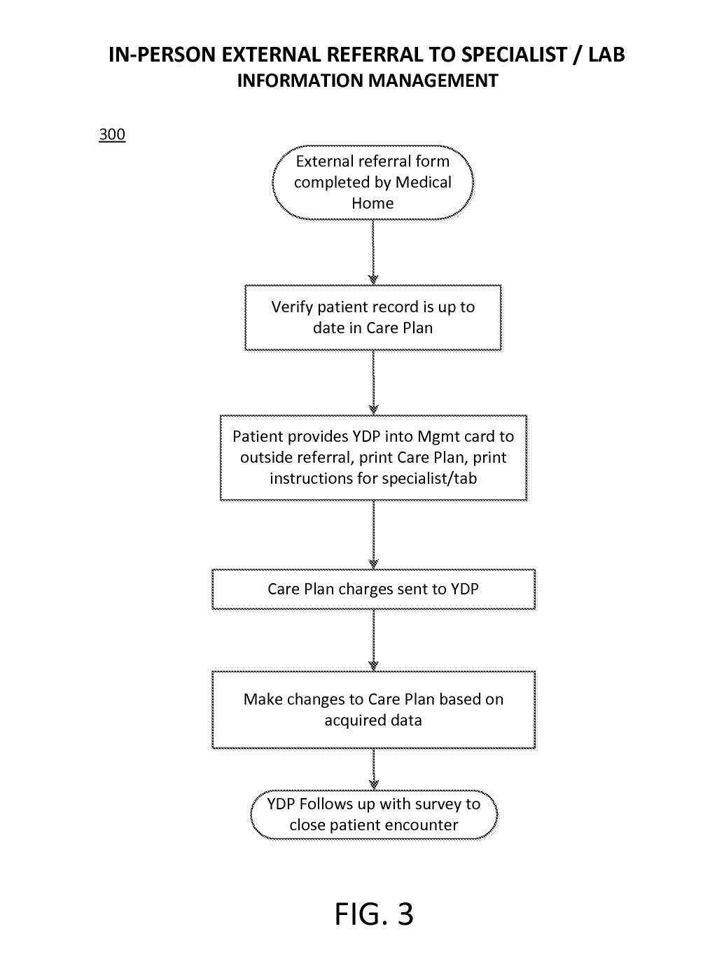

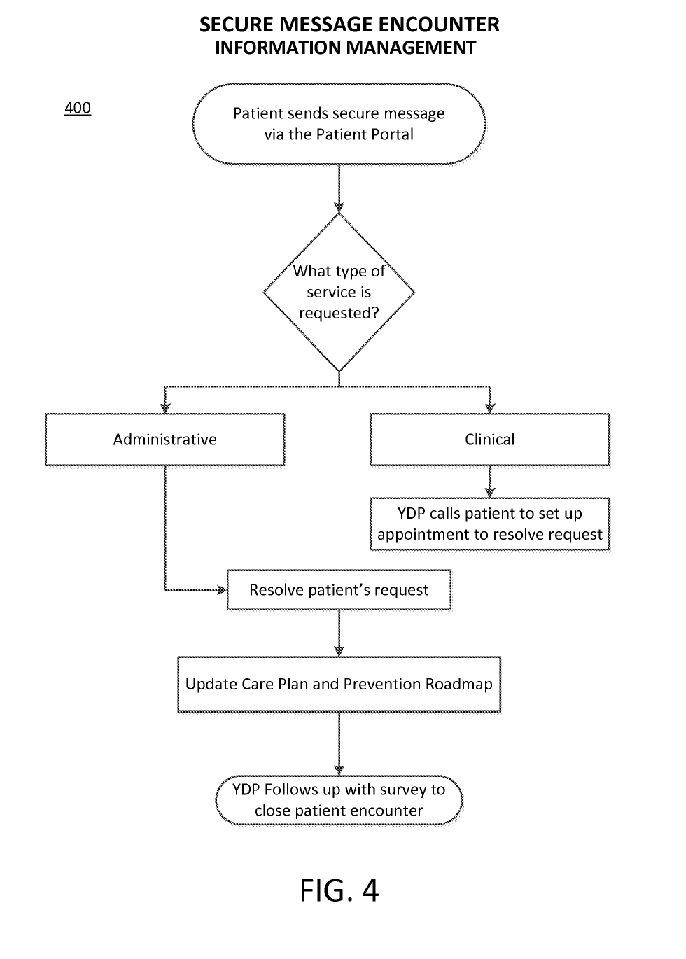

Examples of encounter types and corresponding best practices identified according to aspects of the present disclosure are shown in process flow diagrams in FIGS. 1-13. FIG. 1 shows a process flow diagram 100 illustrating a best workflow practice and standards of practice for information management for an initial patient encounter according to an aspect of the present disclosure. FIG. 2 shows a process flow diagram 200 illustrating a best workflow practice and standards of practice for information management for a nursing home encounter according to an aspect of the present disclosure. FIG. 3 shows a process flow diagram 300 illustrating a best workflow practice and standards of practice for information management for an in-person external referral to a specialist or lab according to an aspect of the present disclosure. FIG. 4 shows a process flow diagram 400 illustrating a best workflow practice and standards of practice for information management for a secure message encounter according to an aspect of the present disclosure.

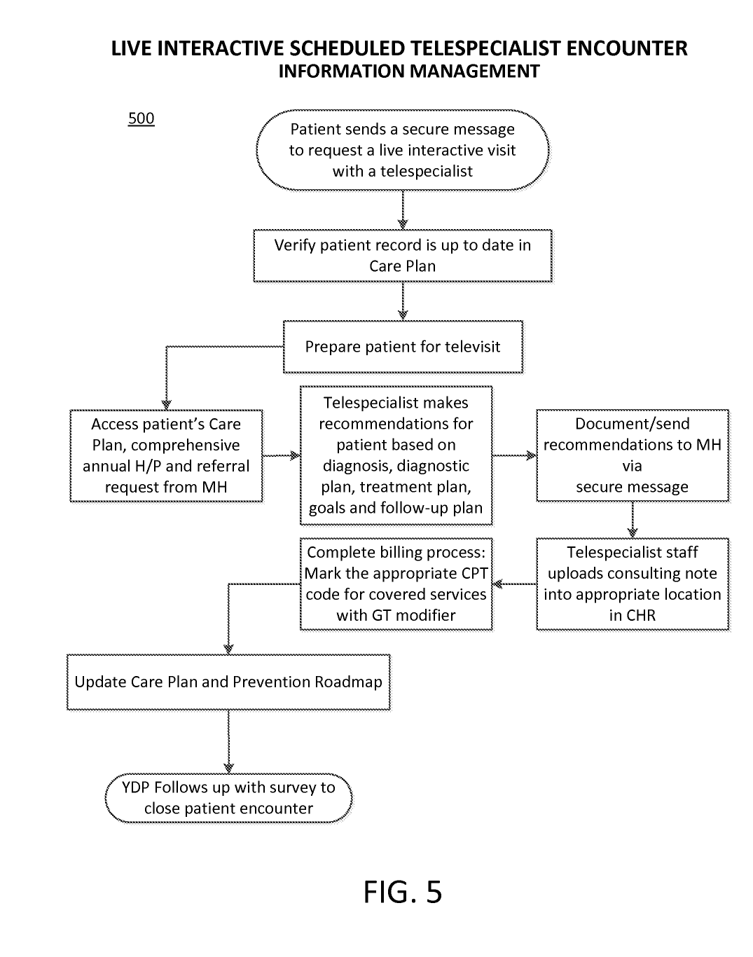

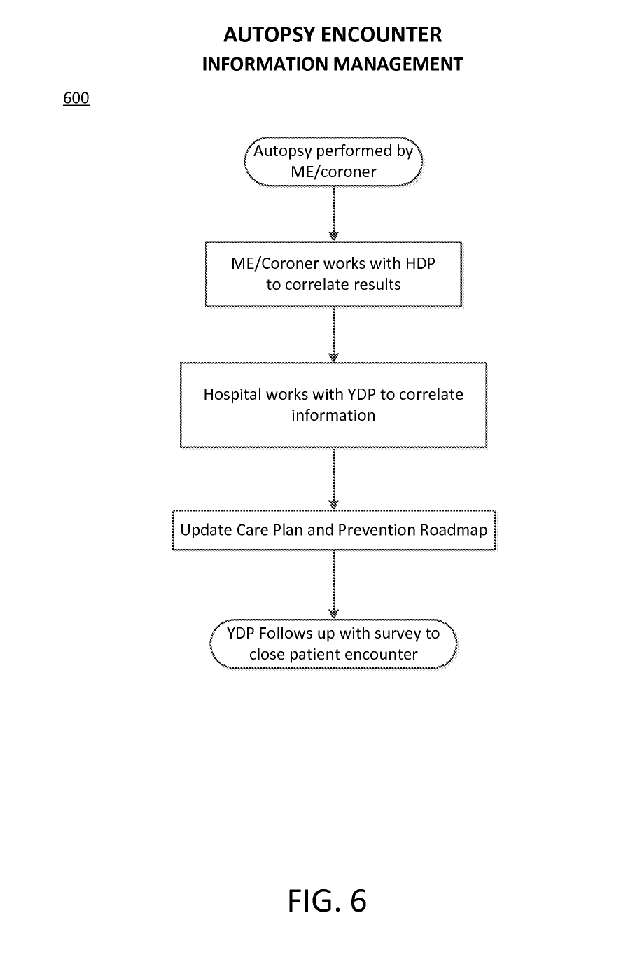

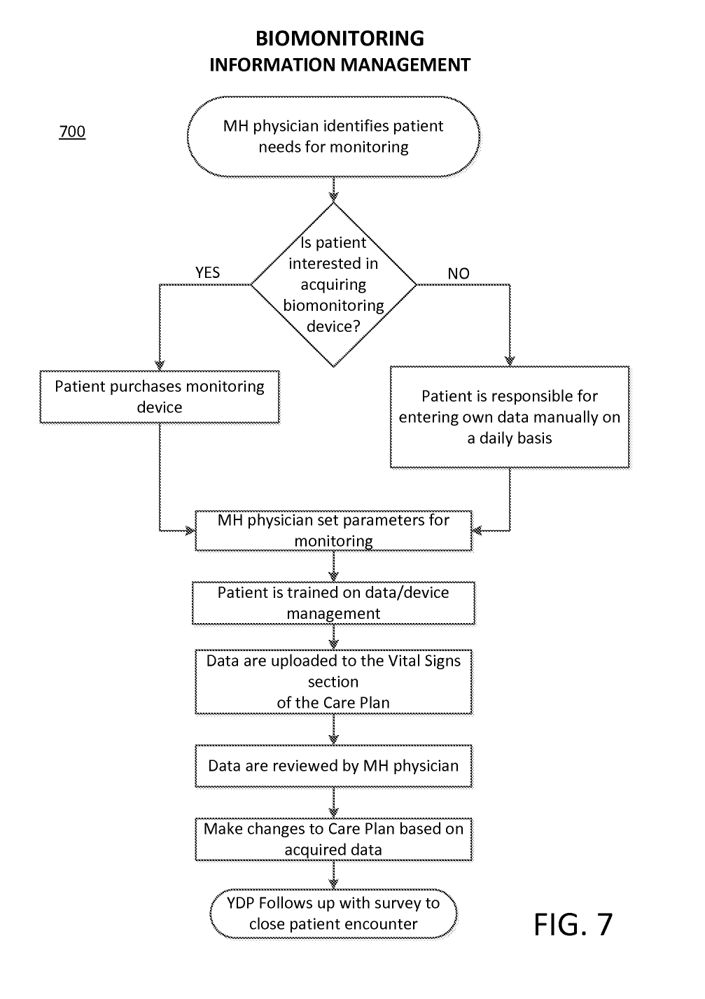

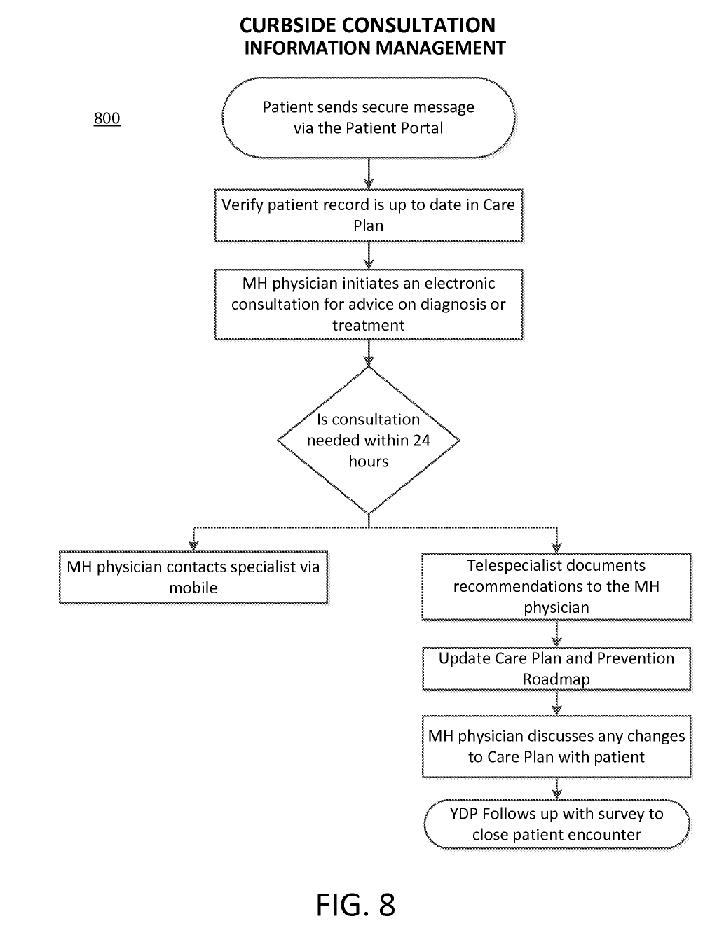

FIG. 5 shows a process flow diagram 500 illustrating a best workflow practice and standards of practice for information management for a live interactive scheduled telespecialist encounter according to an aspect of the present disclosure. FIG. 6 shows a process flow diagram 600 illustrating a best workflow practice and standards of practice for information management for an autopsy encounter according to an aspect of the present disclosure. FIG. 7 shows a process flow diagram 700 illustrating a best workflow practice and standards of practice for information management for a biomonitoring encounter according to an aspect of the present disclosure. FIG. 8 shows a process flow diagram 800 illustrating a best workflow practice and standards of practice for information management for a curbside consultation according to an aspect of the present disclosure.

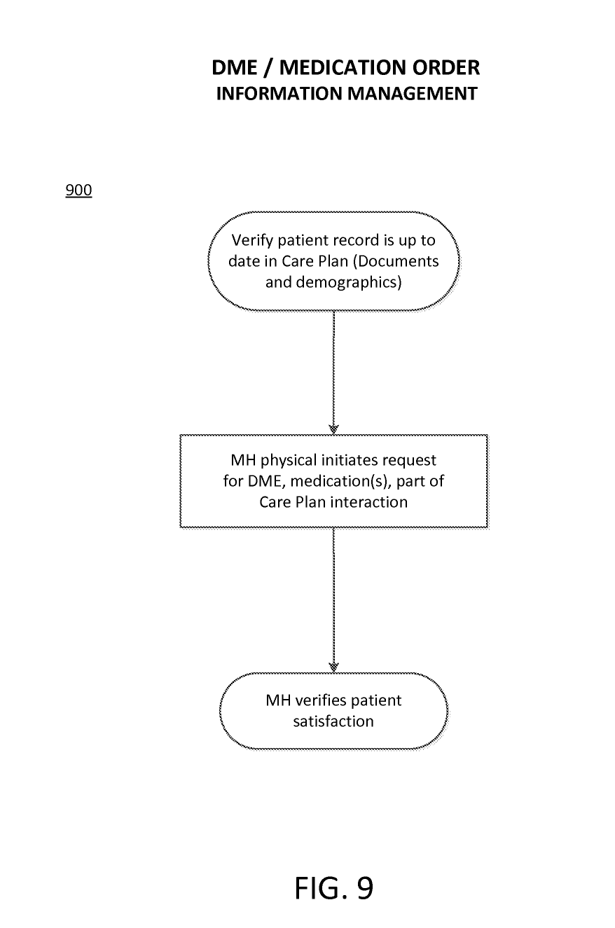

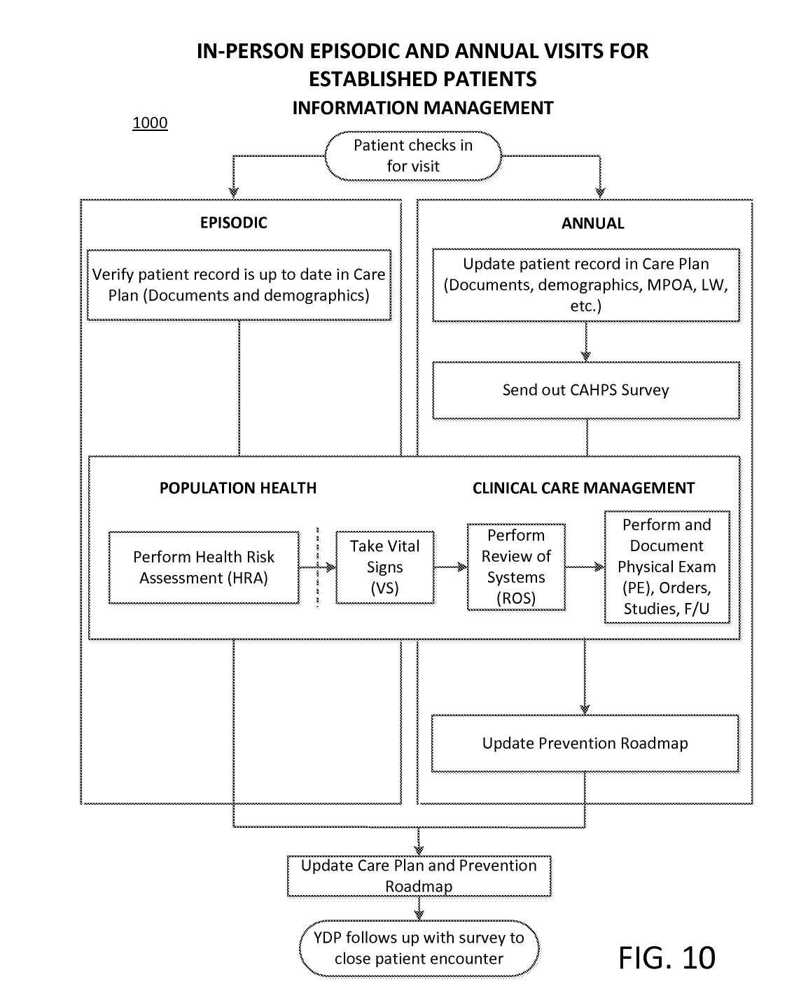

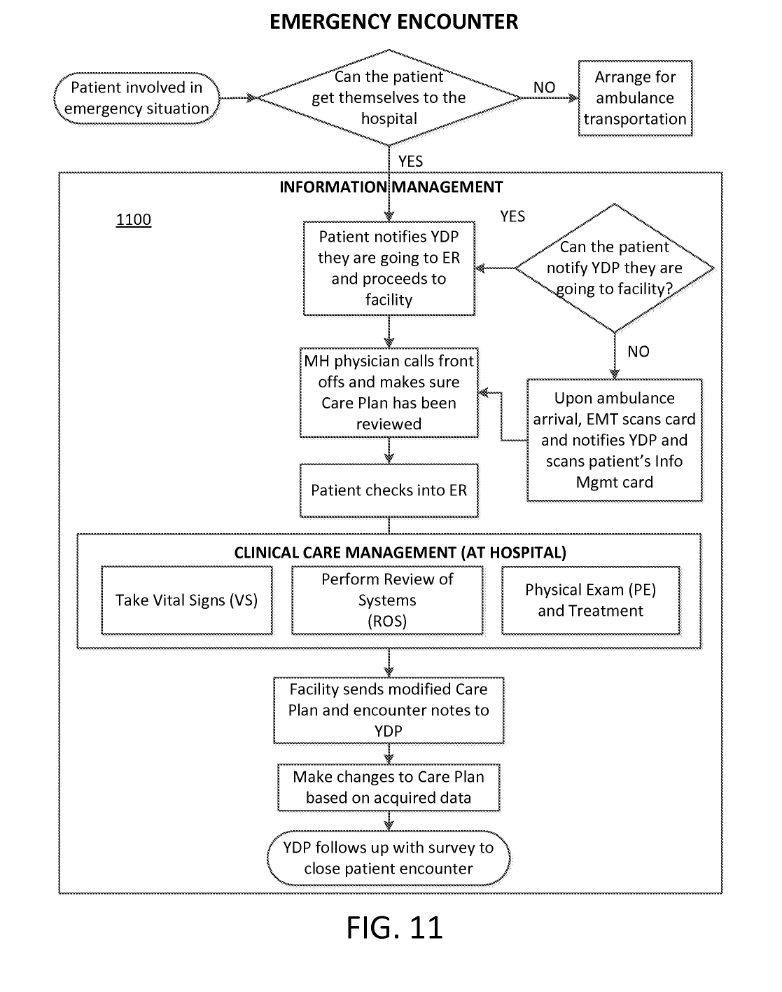

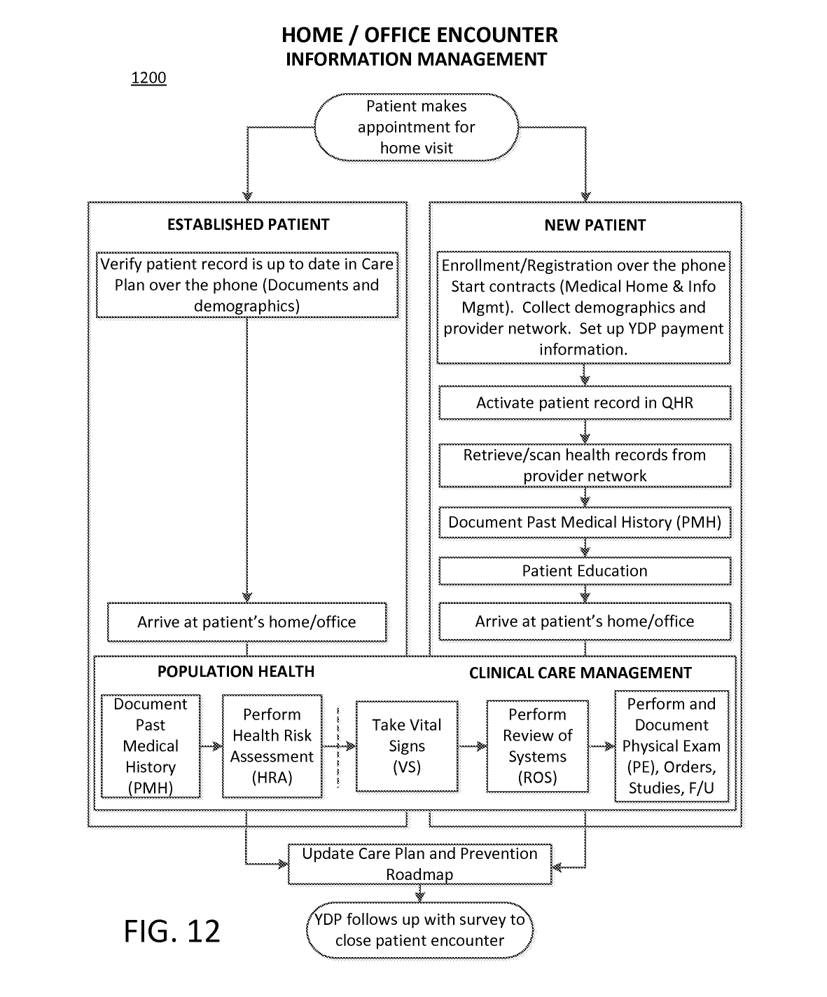

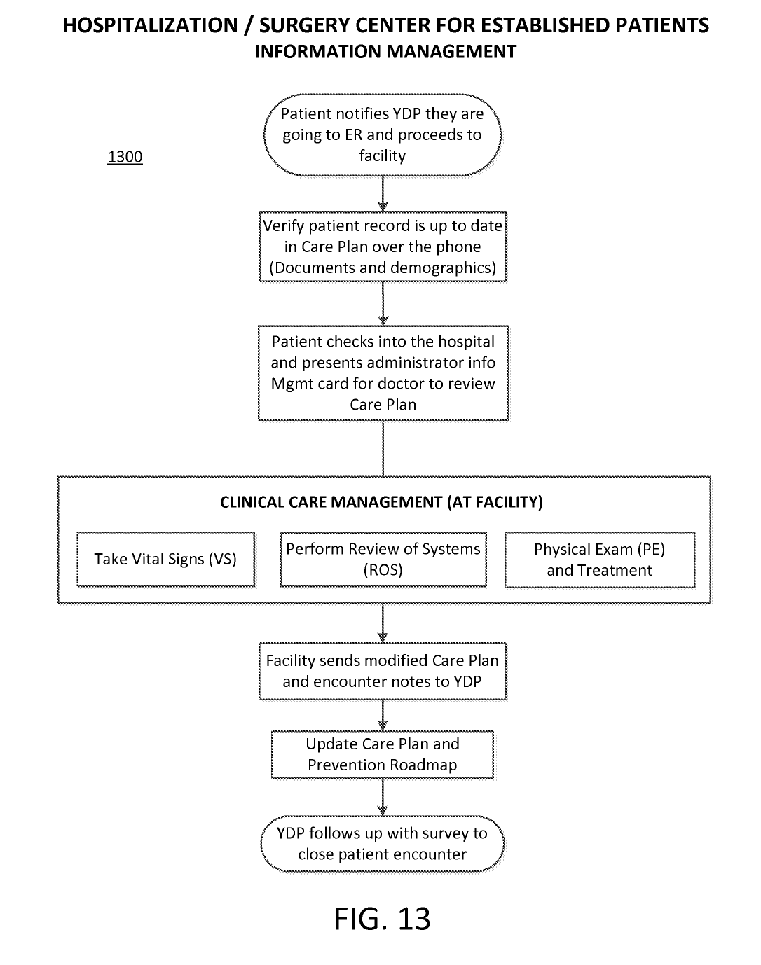

FIG. 9 shows a process flow diagram 900 illustrating a best workflow practice and standards of practice for information management for a durable medical equipment (DME) or/medication order encounter according to an aspect of the present disclosure. FIG. 10 shows a process flow diagram 1000 illustrating a best workflow practice and standards of practice for information management for in-person episodic and annual visits for established patients according to an aspect of the present disclosure. FIG. 11 shows a process flow diagram 1100 illustrating a best workflow practice and standards of practice for information management for an emergency encounter according to an aspect of the present disclosure. FIG. 12 shows a process flow diagram 1200 illustrating a best workflow practice and standards of practice for information management for an in-home or in-office encounter according to an aspect of the present disclosure. FIG. 13 shows a process flow diagram 1300 illustrating a best workflow practice and standards of practice for information management for hospitalization or surgery center encounter for established patients according to an aspect of the present disclosure.

According to aspects of the present disclosure, the model includes types of encounters that are telemedicine based for both the ambulatory and institution based encounters. Types of encounters defined according to aspects of the present disclosure may also include care plan reconciliation, messaging, telephonic to a practitioner, live interactive video to a practitioner, biomonitoring of conditions, curbside consult between practitioners, for example.

### Quality Health Record

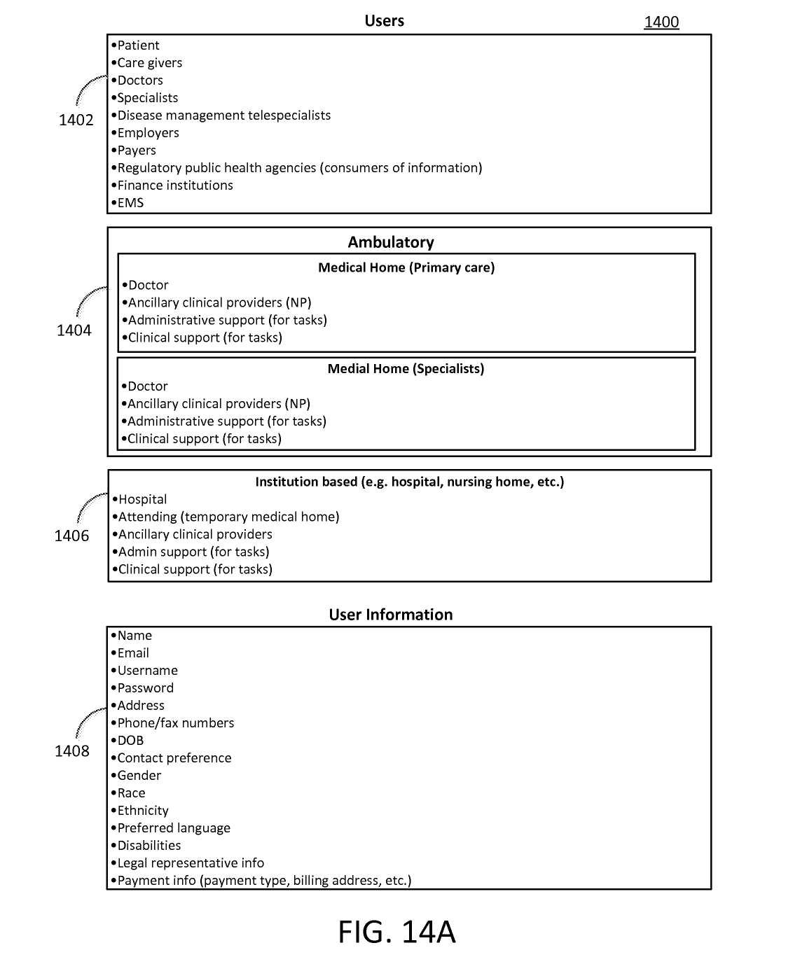

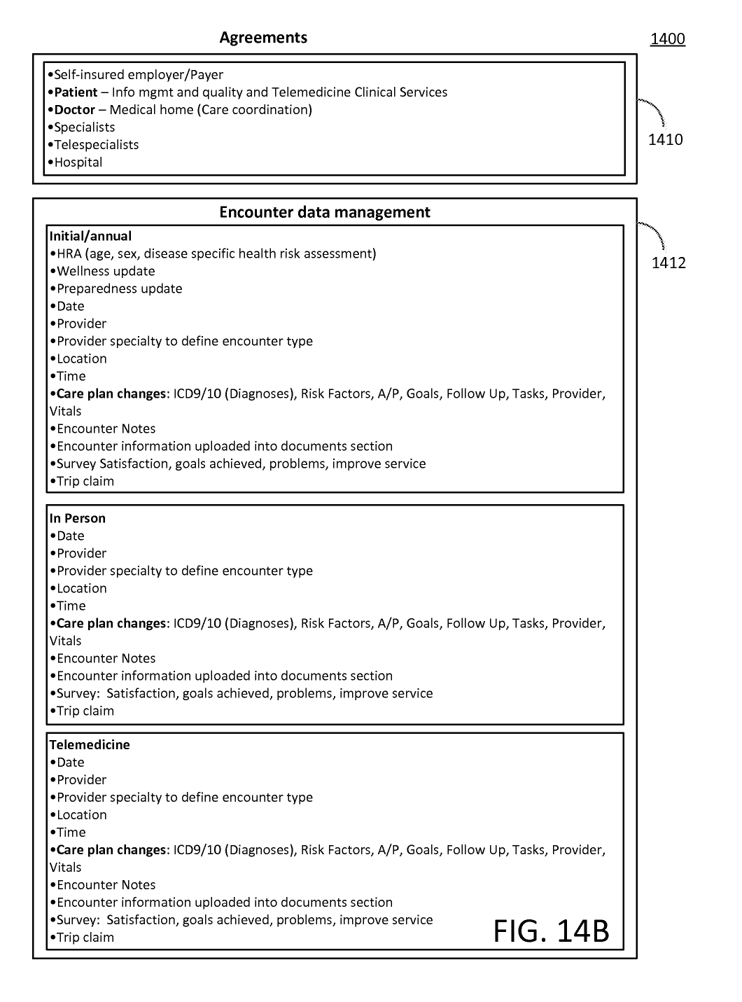

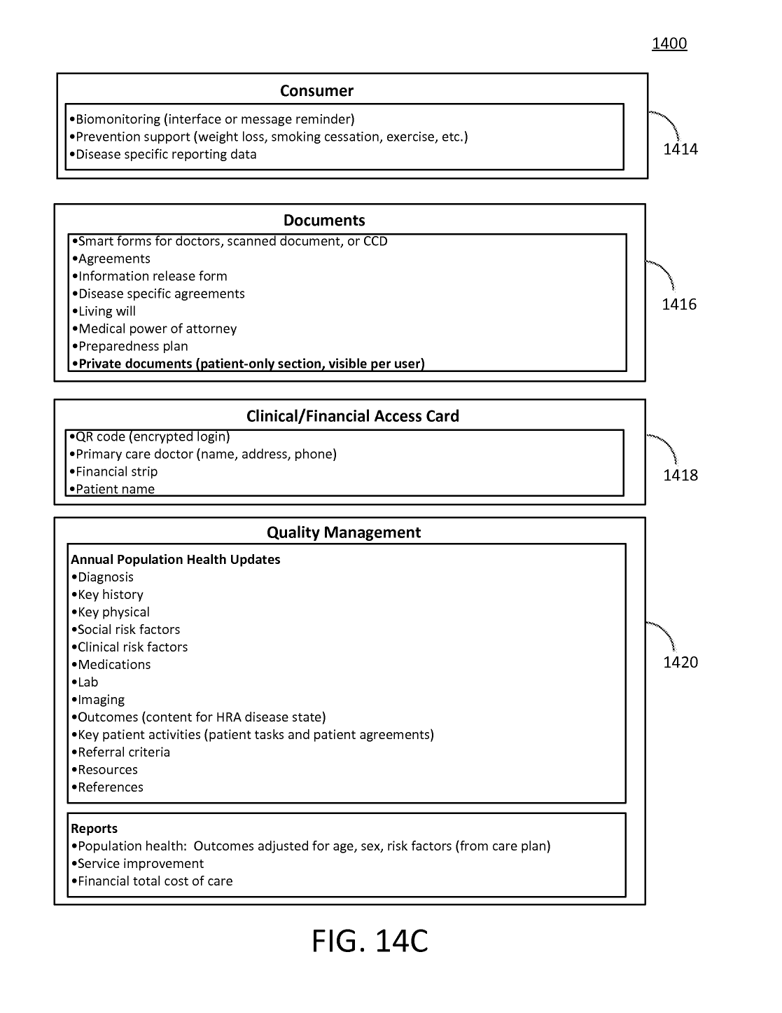

A Quality Health Record 1400, which facilitates automation of the workflows and tasks according to aspects of the present disclosure, is shown in FIGS. 14A-14C. The core data that is collected in the Quality Health Record is part of the patient's ongoing personal health record management system. According to an aspect of the present disclosure, the Quality Health Record 1400 includes a record of users 1402, a record of ambulatory service providers 1404, a record of institution based providers 1406, a record of user information 1408, a record of agreements 1410, a record of encounter data 1412, a record of consumer information 1414, a record of documents, a record of a clinical/financial access card information 1418 and/or a record of quality management information 1420.

In one implementation, the Quality Health Record uses a markup language such as XML/HL7 for data transfer. According to aspects of the present disclosure, data from the Quality Health Record it is used to prepopulate forms and/or electronic systems and is continuously updated.

### Consumer-Provider Information Standards

Aspects of the present disclosure include information management standards to collect actionable quality data at the point of service. According to an aspect of the present disclosure, quality data is collected to improve population health and service and patient education in the ambulatory and institutional setting.

For example, in an ambulatory setting there may be two standards as part of a patient's annual exam. According to an aspect of the present disclosure, if patients have a timely annual in-person exam, they are then eligible to have telemedicine services in the upcoming year with their providers. In this example, the first of two information management standards as part of the annual exam defines an automated annual age, sex, disease specific HEDIS measures (Health Risk Assessment) to define the “truth” for the patient and goals for wellness and disease management. The second of two information standards as part of the annual exam defines an annual prevention/preparedness program discussion between the patient and their primary care provider to select one prevention goal for the year, define disease management goals for the year, and update their medical power of attorney/living will and personal preparedness plan for disasters and emergencies.

According to another aspect of the present disclosure two discharge standards are defined in an institutional setting. The first discharge standard includes completion of transition checklist that assures that the patient's required reporting data is completed. The second discharge standard includes providing an updated care plan that has been communicated to all of the patient's providers for follow up after discharge and ensures that consumer understands their plan of care.

According to another aspect of the present disclosure, three practice standards are defined for all encounters. The first practice standard defined for all encounters includes providing that a care plan is updated to assure care coordination and patient knows the plan, goals, and their responsibilities. The second practice standard defined for all encounters includes providing that encounter information is uploaded into a care plan, by scan, fax, or other electronic transmission, for example. The third practice standard defined for all encounters includes providing that follow up of the encounter is established to “close the loop” on care to collect outcomes of care on that encounter.

A provider improvement methodology according to an aspect of the present disclosure includes two components. A first component is targeted to improve future quality and cost, i.e., value. A second component is targeted to improve provider knowledge of disease management and treatment updates. According to this aspect of the disclosure providers receive continuing education credit for using a Practice-Based Continuing Education Program.

A program to improve future quality according to aspects of the present disclosure uses data from the Quality Health Record and data from point of service claims data to provide a number of peer comparison reports to providers for continuing education credit. According to an aspect of the present disclosure the reports include a population health report, an ambulatory report including HEDIS measures adjusted for patient social and clinical factors and patient adherence, an inpatient report including required reporting adjusted for patient social and clinical factors, a service/patient engagement report and a cost of care report.

Aspects of the present disclosure include a program to improve provider knowledge annually to assure they are up-to-date. For example, based on the providers ten most common diseases, they review the best practice from a best treatment protocol and document their treatment preferences. According to an aspect of the present disclosure, the best treatment practice also defines the core tasks that patients should follow for a disease state and the population health outcomes that should be collected annually as part of the patient's annual age, sex, and disease specific health risk assessment.

Aspects of the present disclosure also include a method to drive adoption by providers and consumers. The method includes providing incentives for adopting the model for total quality management of healthcare according to aspects of the present disclosure. In one example, if providers are active in the Practice based Continuing Education Program and follow these standards, they are paid at the point of service completion. Standards for point of service payment may include requiring that the care plan is updated, requiring that encounter information is uploaded and requiring that a follow up survey is sent, for example.

According to an aspect of the present disclosure, certain consumer responsibilities are defined in their care plan. Incentives are provided for the consumer to meet their defined responsibilities under the plan. For example, if the consumer follows communication standards for their annual visit to a provider, they are then eligible to receive services in the upcoming year via telemedicine with their provider network. Providers are incentivized by payment for certain telemedicine services.

### Provider Care Card

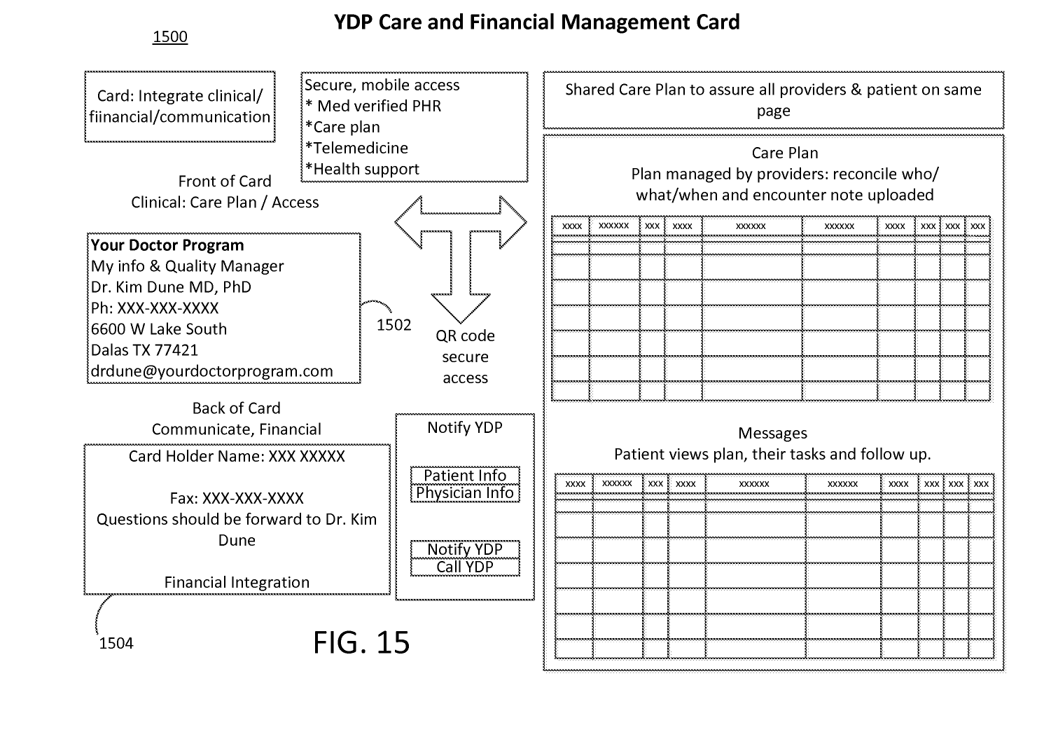

According to another aspect of the present disclosure, a provider care card is provided to integrate patient clinical and financial data for point of service payment if information management standards are met. Referring to FIG. 15, in one example, a front side 1502 of the provider care card identifies a patient and clinical information manager defines the patient identity access to their secure online record (patient id such as personal qr code or biometric (iris scan, fingerprint scanner). In one example, the front side 1502 of the provider care card provides access to the patient information for management. A back side of the provider care card 1504 enables management of financial information and integrates financial data for healthcare payment (patient and payer—e.g. FSA/Credit card/HSA/payer) with instructions for information management for point of service payment.

According to this aspect of the present disclosure, the provider card provides a tool for a patient's information to be securely accessed and managed, embeds information management standards for the encounter information to be collected and reconciled with the patient's overall healthcare plan, collects information at the point of care, pays providers if they follow information management standards for point of service payment.

The provider care card assures that practitioners have access to accurate and actionable information for patients being encountered. It also provides contact information to enable the patient to contact the patient's designated physician.

For point of service payment, the practitioner seeing the patient at the time of card use then can be paid more quickly if they follow information management instructions on the back side 1504 of the card provider care card. According to aspects of the present disclosure, the provider care card enables emergency care personnel to have access to the patient's core information in a HIPAA compliant fashion by accessing the patient's care plan via the QR/biometric reader.

According to an aspect of the present disclosure the provider care card can be issued and managed by an information and quality management service. When a patient enrolls for information and quality management service, core information of the patient is collected by the information and quality management service and the patient's online care plan for clinical information is populated. According to an aspect of the present disclosure, the information and quality management service also collect the patient's personal payment information and payer payment information.

The information and quality management service then issue a provider care card for the patient. The issued provider care card includes has actionable core clinical and financial data on the card/access via mobile devices/computer scanners to access and manage clinical and financial data at the point of service. Patients can use their provider care card for everyday healthcare interaction with their providers for clinical and financial information management. Emergency personnel can access the core information for the patient to treat at the point of emergency. According to an aspect of the present disclosure, providers who follow information management instructions on the provider care card, are paid at the point of service completion. According to another aspect of the present disclosure, the provider care card can be used for information management alone by the patient or the patient's designated information manager. The financial aspect of the card could be a health credit card or other financial transaction vehicle, for example.

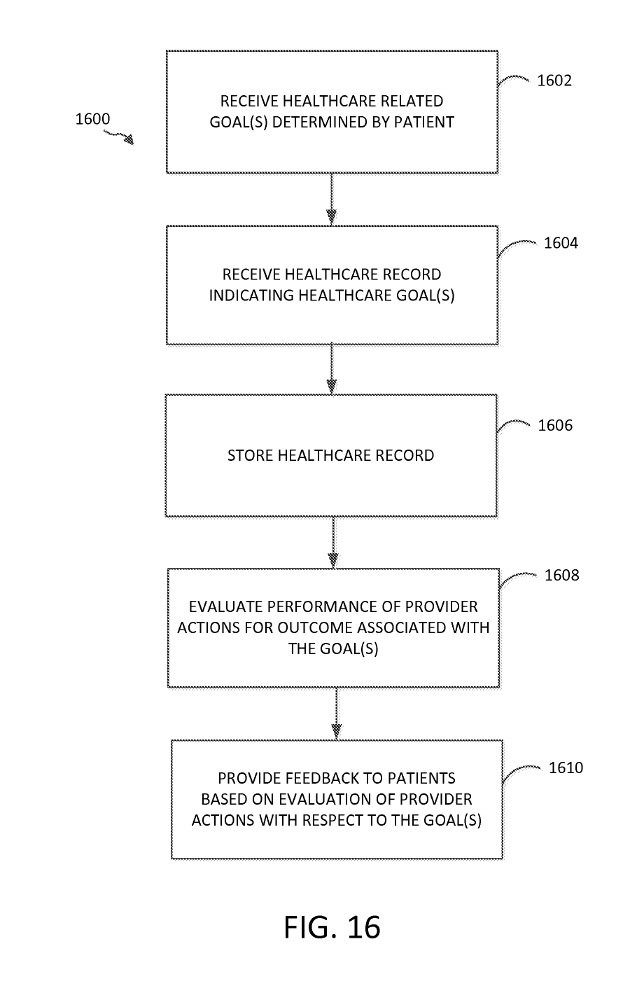

A method for total quality management in healthcare data management according to an aspect of the present disclosure is described with reference to FIG. 16. The method 1600 includes receiving at least one healthcare related goal determined by a patient at block 1602 and receiving a healthcare record associated with the patient at block 1604. According to an aspect of the present disclosure, the healthcare record pertains to the healthcare related goal(s) from at least one healthcare service provider. The method also includes storing the healthcare record in a database at block 1606 and evaluating performance of an outcome for an activity of each of the healthcare service provider(s) at block 1608. According to an aspect of the present disclosure, the outcome is associated with meeting the healthcare related goal(s). The method also includes providing feedback to the patient regarding the performance evaluation of the healthcare service provider(s) at block 1610.

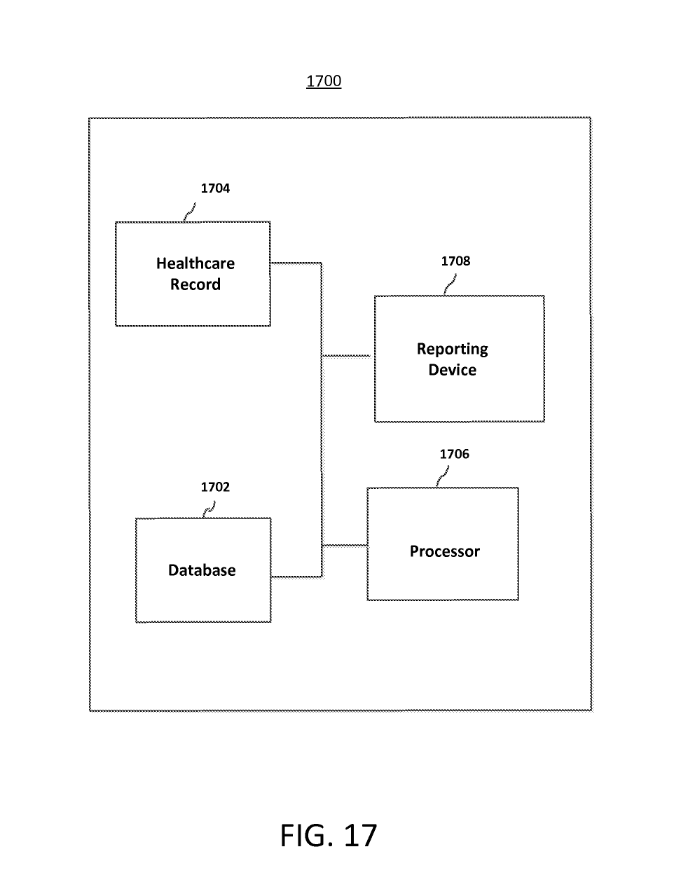

A total quality management system for healthcare according to another aspect of the present disclosure is described with reference to FIG. 17. The system includes a database 1702 configured to receive at least one healthcare related goal. The system also includes at least one healthcare record 1704 associated with a patient and indicating the healthcare related goal(s). According to an aspect of the present disclosure, the healthcare record is based on an outcome of an activity for each of the healthcare service providers wherein the outcome is associated with meeting the healthcare related goal(s). At least one processor 1706 coupled to the database 1702 is configured to compare the outcome with the healthcare related goal(s) and provide feedback based on the comparison to the patient. The system 1700 also includes a reporting device 1708 coupled to the processor(s) 1706 and configured to display the feedback.

For a firmware and/or software implementation, the methodologies and models described herein according to aspects of the present disclosure may be implemented with modules (e.g., procedures, functions, and so on) that perform the functions, methods and/or processes described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “having,” “having,” “includes,” “including” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It should be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the present disclosure has been described in connection with the embodiments illustrated in the accompanying drawings, it is not limited thereto. Persons with skill in the art will recognize that embodiments of the present disclosure may be applied to other types of memory devices. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for total quality management in healthcare data management, the method comprising the steps of:
receiving at least one healthcare related goal determined by a patient;
receiving a healthcare record associated with the patient and pertaining to the at least one healthcare related goal from at least one healthcare service provider;
storing the healthcare record in a database;
evaluating performance of an outcome for an activity of each of the at least one healthcare service provider, wherein the outcome is associated with meeting the at least one healthcare related goal; and
providing feedback to the patient regarding the performance evaluation of the at least one healthcare service provider.

2. The method of claim 1, wherein storing the healthcare record comprises:
formatting the healthcare record in a patient-oriented format.

3. The method of claim 1, further comprising:
receiving a health update from the patient; and
storing the health update in the database.

4. The method of claim 3, further comprising:
providing access to the health update to a third party.

5. The method of claim 4, wherein the third party comprises at least one of: i) the at least one healthcare service provider, ii) an employer, and iii) a health insurance provider.

6. The method of claim 3, further comprising:
vetting the health update to conform to a health care records standard.

7. The method of claim 3, further comprising:
integrating the healthcare record with the health update in the database.

8. The method of claim 1, wherein the at least one healthcare service provider includes at least one of: i) a doctor, ii) medical institution, and iii) a nurse.

9. The method of claim 1, wherein the at least one healthcare service provider comprises a first healthcare service provider and a second healthcare service provider, and further comprises:
comparing the performance evaluation of the first healthcare service provider with the performance evaluation of the second health care service provider.

10. The method of claim 8, providing the comparison to at least one of: i) the patient, ii) the first healthcare service provider, iii) the second healthcare service provider, and iv) a healthcare service payor.

11. A total quality management system for healthcare, the system comprising:
a database configured to receive at least one healthcare related goal and at least one healthcare record associated with a patient and indicating the at least one healthcare related goal, wherein the healthcare record is based on an outcome of an activity for each of the at least one healthcare service provider, and the outcome is associated with meeting the at least one healthcare related goal;
at least one processor coupled to the at least one database and configured to compare the outcome with the at least one healthcare related goal and provide feedback based on the comparison to the patient; and
a reporting device coupled to the at least one processor configured to display the feedback.

12. The system of claim 11, wherein the at least one processor is further configured to format the at least one healthcare record in a patient-oriented format.

13. The system of claim 11, wherein the at least one processor is further configured to receive and store a health update from the patient to the database.

14. The system of claim 13, wherein the at least one processor further configured to transmit the feedback to a third party.

15. The system of claim 14, wherein the third party comprises at least one of: i) the at least one healthcare service provider, ii) an employer, and iii) a health insurance provider.

16. The system of claim 11, wherein the at least one healthcare service provider includes at least one of: i) a doctor, ii) a medical institution, and iii) a nurse.

17. The system of claim 11, wherein the at least one healthcare service provider comprises a first healthcare service provider and a second healthcare service provider; and the at least one processor is further configured compare the performance evaluation of the first healthcare service provider with the performance evaluation of the second healthcare service provider.

18. The system of claim 17, wherein the at least one processor is further configured to report the comparison to at least one of: i) the patient, ii) the first healthcare service provider, iii) the second healthcare service provider, and iv) a healthcare service payor.

19. A non-transitory computer-readable medium product, the non-transitory computer-readable medium comprising instructions that, when executed by at least one processor, perform a method, the method comprising:
receiving at least one healthcare related goal determined by a patient;
receiving a healthcare record associated with the patient and pertaining to the at least one healthcare related goal from at least one healthcare service provider;
storing the healthcare record in a database;
evaluating performance of an outcome for an activity of each of the at least one healthcare service provider, wherein the outcome is associated with meeting the at least one healthcare related goal; and
providing feedback to the patient regarding the performance evaluation of the at least one healthcare service provider.

20. The non-transitory computer-readable medium of claim 19, wherein the medium comprises at least one of: i) a non-volatile memory, ii) a hard disk, iii) an EPROM, and iv) a cloud-based resource.
